(19) United States
(12) Patent Application Publication
(10) Pub. No.: US 2024/0357679 A1
(43) Pub. Date: Oct. 24, 2024

(54) Wireless Communication Method, Wireless Access Device, and Wireless Terminal Device Capable of Supporting a Multi-Link Operation Mode

(71) Applicant: Realtek Semiconductor Corp., HsinChu (TW)

(72) Inventor: Hsiu-Ming Tu, HsinChu (TW)

(73) Assignee: Realtek Semiconductor Corp., HsinChu (TW)

(21) Appl. No.: 18/624,140

(22) Filed: Apr. 2, 2024

(30) Foreign Application Priority Data
Apr. 19, 2023 (TW) 112114507

(51) Int. Cl. H04W 76/15; H04L 5/00; H04W 72/0446; H04W 72/121; H04W 84/12

(52) U.S. Cl. CPC H04W 76/15; H04L 5/0055; H04W 72/0446; H04W 72/121; H04W 84/12

(57) ABSTRACT

A wireless communication method capable of supporting the multi-link operation mode includes establishing a data connection between a wireless access device and a wireless terminal device through a first link and a second link, identifying the first link and the second link, acquiring link status information of the first link and the second link, and allocating uplink transmission data, downlink transmission data, or a data link layer management flow to the first link and the second link by the wireless access device according to the link status information of the first link and the second link. The first link and the second link have different frequencies.

### BACKGROUND OF THE INVENTION

### 1. Field of the Invention

The present invention illustrates a wireless communication method, a wireless access device, and a wireless terminal device, and more particularly, a wireless communication method, a wireless access device, and a wireless terminal device capable of allocating data under different links for reducing latency and data collisions.

### 2. Description of the Prior Art

With the rapid advancement of technology, the 7-th generation of wireless fidelity (i.e., Wi-Fi 7) technology is also approaching. In conventional Wi-Fi technologies, since several links are operated independently, a link aggregation function cannot be performed. Further, in conventional Wi-Fi technologies, only a single link connection (SLO) function can be performed. Therefore, Wi-Fi 7 can be regarded as an extremely high throughput (EHT) communication technology. Wi-Fi 7 supports a multi-link operation (MLO) function. It can simultaneously aggregate several channels on different frequency bands. Further, Wi-Fi 7 can support to access multiple resource units (MRU). The MRU can carry data on several frequency bands. However, when the MLO function is performed, a transmission interference problem must be overcome.

Currently, in order to overcome the transmission interference problem of the MLO, a strategy of redesigning hardware is often used. Another strategy is to limit aggregated channels to be in a transmission state or a reception state at the same time. Alternatively, only a single link can be enabled for data communications at the same time. However, in Wi-Fi 7 applications, if an uplink transmission and a down link transmission are frequently used for exchanging data, problems of data collision and high latency for multi-users must be overcome.

Therefore, to develop a wireless communication method capable of optimizing resource allocations for all links and supporting the MLO function is an important design issue.

### SUMMARY OF THE INVENTION

In an embodiment of the present invention, a wireless access device capable of supporting a multi-link operation mode is disclosed. The wireless access device comprises a first sub-access device, a second sub-access device, a transmission allocation device, and a group scheduling device. The first sub-access device is configured to establish a first link to a wireless terminal device. The first sub-access device comprises a first link access analysis unit configured to identify and analyze the first link, and a first access transceiver unit configured to transmit data. The second sub-access device is configured to establish a second link to the wireless terminal device. The second sub-access device comprises a second link access analysis unit configured to identify and analyze the second link, and a second access transceiver unit configured to transmit data. The transmission allocation device is coupled to the first sub-access device and the second sub-access device. The transmission allocation device is configured to determine communication modes of an uplink transmission and a downlink transmission, or determine allocation modes of a data link layer management flow, the first link, and the second link. The group scheduling device is coupled to the first sub-access device, the second sub-access device, and the transmission allocation device. The group scheduling device is configured to partition a plurality of wireless terminal devices into at least two groups. The group scheduling device is configured to control the transmission allocation device to transmit downlink transmission data to different wireless terminal device groups at different time intervals.

In another embodiment of the present invention, a wireless terminal device capable of supporting the multi-link operation is disclosed. The wireless terminal device comprises a first sub-terminal device, a second sub-terminal device, a receiving state detection device, and a terminal transmission allocation device. The first sub-terminal device is configured to establish a first link to a wireless access device. The first sub-terminal device comprises a first link terminal analysis unit configured to identify and analyze the first link, and a first terminal transceiver unit configured to receive data. The second sub-terminal device is configured to establish a second link to the wireless access device. The second sub-terminal device comprises a second link terminal analysis unit configured to identify and analyze the second link, and a second terminal transceiver unit configured to receive data. The receiving state detection device is coupled to the first sub-terminal device and the second sub-terminal device. The receiving state detection device is configured to detect receiving states of the first link and the second link. The receiving state detection device is configured to generate a block acknowledgment message according to the receiving states. The terminal transmission allocation device is coupled to the first sub-terminal device and the second sub-terminal device. The terminal transmission allocation device is configured to determine allocation modes of a data link layer management flow, the first link, and the second link.

In another embodiment of the present invention, a wireless communication method capable of supporting the multi-link operation mode is disclosed. The wireless communication method comprises establishing a data connection between a wireless access device and a wireless terminal device through a first link and a second link, identifying the first link and the second link, acquiring link status information of the first link and the second link, and allocating uplink transmission data, downlink transmission data, or a data link layer management flow to the first link and the second link by the wireless access device according to the link status information of the first link and the second link. The first link and the second link have different frequencies.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a wireless communication system according to an embodiment of the present invention.

FIG. 2 is an illustration of allocating uplink transmission data and downlink transmission data to different links of the wireless communication system in FIG. 1.

FIG. 3 is an illustration of partitioning a plurality of wireless terminals and then transmitting downlink transmission data to different wireless terminal device groups at different time intervals of the wireless communication system in FIG. 1.

FIG. 4 is an illustration of allocating a data link layer management flow and control frame data to a specific link of the wireless communication system in FIG. 1.

FIG. 5 is an illustration of allocating a block acknowledgment request and a block acknowledgment message to a specific link of the wireless communication system in FIG. 1.

FIG. 6 is an illustration of allocating a block acknowledgment request and a block acknowledgment message to a specific link for multi-users of the wireless communication system in FIG. 1.

FIG. 7 is an illustration of time points for multi-users of the wireless communication system in FIG. 1.

FIG. 8 is an illustration of introducing an unexpected link busy state for multi-users to the wireless communication system in FIG. 1.

FIG. 9 is an illustration of introducing an expected link busy state of the wireless communication system in FIG. 1.

FIG. 10 is an illustration of introducing an expected link power saving state for multi-users to the wireless communication system in FIG. 1.

### DETAILED DESCRIPTION

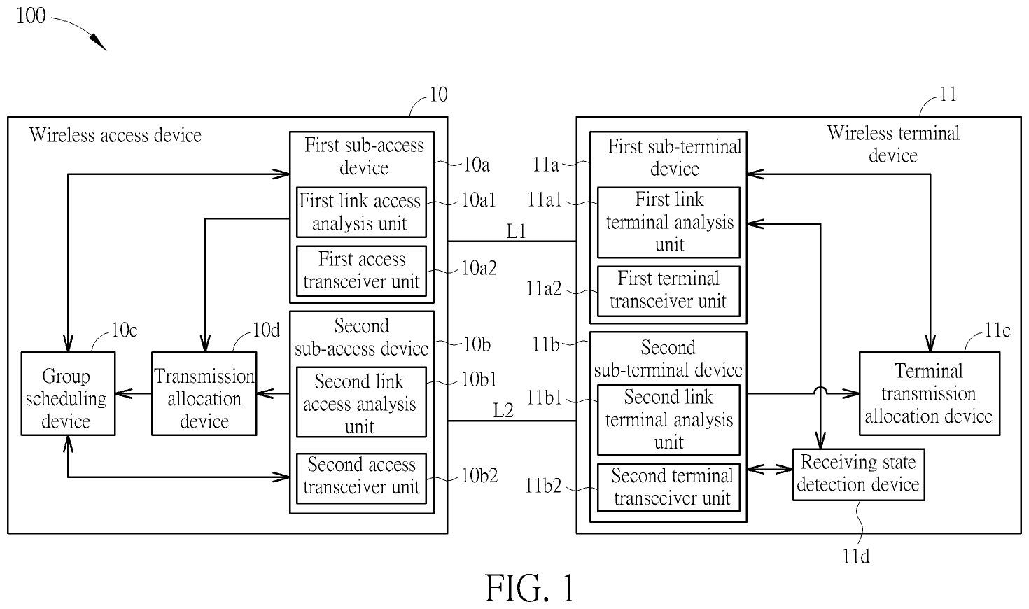

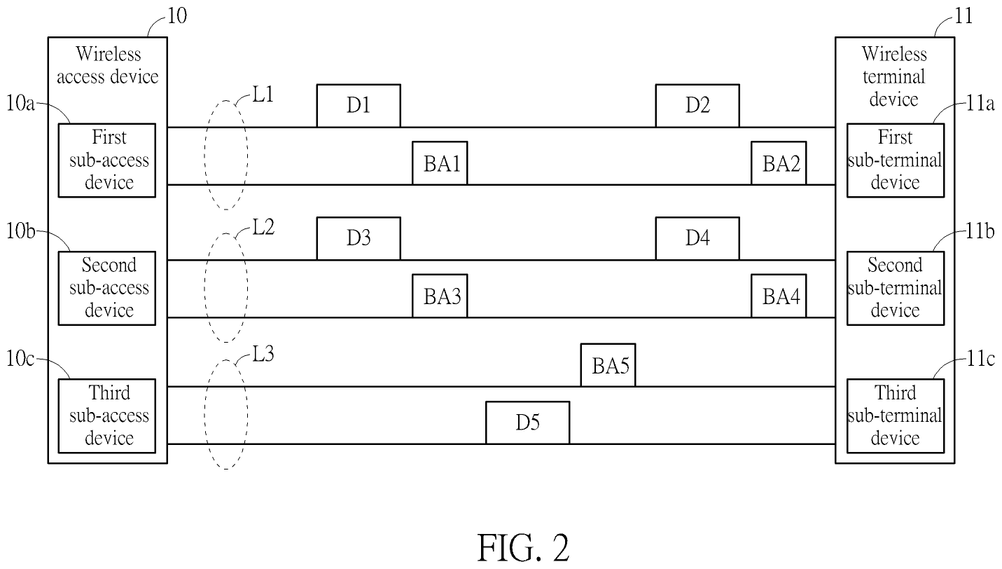

FIG. 1 is a block diagram of a wireless communication system 100 according to an embodiment of the present invention. The wireless communication system 100 can be applied to a multi-link operation (MLO) of Wi-Fi 7. The MLO can simultaneously aggregate several channels on different frequency bands. The wireless communication system 100 includes a wireless access device 10 and a wireless terminal device 11. The wireless access device 10 includes a first sub-access device 10a, a second sub-access device 10b, a transmission allocation device 10d, and a group scheduling device 10e. The first sub-access device 10a is used for establishing a first link L1 to the wireless terminal device 11. The second sub-access device 10b is used for establishing a second link L2 to the wireless terminal device 11. Here, the number of sub-access devices is not limited by the wireless access device 10. For example, a third sub-access device 10c (as shown in FIG. 2) can be introduced to the wireless access device 10 for establishing a third link L3 to the wireless terminal device 11. In the wireless communication system 100, the first link L1 and the second link L2 may be two links with different frequencies. For example, the first link L1 has a frequency at 2.4 GHz. The second link L2 has a frequency at 5 GHz. The first sub-access device 10a includes a first link access analysis unit 10a1 and a first access transceiver unit 10a2. The first link access analysis unit 10a1 is used for identifying and analyzing the first link L1. The first access transceiver unit 10a2 is used for transmitting data through the first link L1. The second sub-access device 10b includes a second link access analysis unit 10b1 and a second access transceiver unit 10b2. The second link access analysis unit 10b1 is used for identifying and analyzing the second link L2. The second access transceiver unit 10b2 is used for transmitting data through the second link L2. The transmission allocation device 10d is coupled to the first sub-access device 10a and the second sub-access device 10b. The transmission allocation device 10d is used for determining communication modes of an uplink transmission and a downlink transmission, or determining allocation modes of a data link layer management flow, the first link L1, and the second link L2. The group scheduling device 10e is coupled to the first sub-access device 10a, the second sub-access device 10b, and the transmission allocation device 10d. Particularly, when the wireless communication system 100 includes a plurality of wireless terminal devices, the group scheduling device 10e can be used for partitioning the plurality of wireless terminal devices into at least two groups. Further, the group scheduling device 10e can be used for controlling the transmission allocation device 10d to transmit downlink transmission data to different wireless terminal device groups at different time intervals.

The wireless terminal device 11 of the wireless communication system 100 includes a first sub-terminal device 11a, a second sub-terminal device 11b, a receiving state detection device 11d, and a terminal transmission allocation device lie. The first sub-terminal device 11a is used for establishing the first link Li to a wireless access device 10. The first sub-terminal device 11a includes a first link terminal analysis unit 11a1 and a first terminal transceiver unit 11a2. The first link terminal analysis unit 11a1 is used for identifying and analyzing the first link L1. The first terminal transceiver unit 11a2 is used for receiving data through the first link L1. The second sub-terminal device 11b includes a second link terminal analysis unit 11b1 and a second terminal transceiver unit 11b2. The second link terminal analysis unit 11b1 is used for identifying and analyzing the second link L2. The second terminal transceiver unit 11b2 is used for receiving data through the second link L2. Here, the number of sub-terminal devices is not limited by the wireless terminal device 11. For example, a third sub-terminal device 11c (as shown in FIG. 2) can be introduced to the wireless terminal device 11 for establishing a third link L3 to the wireless access device 10. The receiving state detection device 11d is coupled to the first sub-terminal device 11a and the second sub-terminal device 11b for detecting receiving states of the first link L1 and the second link L2. Further, the receiving state detection device 11d can generate a block acknowledgment message according to the receiving states. The terminal transmission allocation device lie is coupled to the first sub-terminal device 11a and the second sub-terminal device 11b for determining allocation modes of the data link layer management flow, the first link L1, and the second link L2. Various data allocation modes of the wireless communication system 100 are illustrated below.

FIG. 2 is an illustration of allocating uplink transmission data and downlink transmission data to different links of the wireless communication system 100. The left side in FIG. 2 is the wireless access device 10. The right side in FIG. 2 is the wireless terminal device 11. The wireless access device 10 communicates with the wireless terminal device 11 through the first link L1, the second link L2, and the third link L3. In FIG. 2, the transmission allocation device 10d of the wireless access device 10 can allocate uplink transmission data of the wireless access device 10 to the first link L1 and the second link L2. Further, the downlink transmission data of the wireless access device 10 is allocated to the third link L3. By definition, the uplink transmission is defined as data communications from the wireless terminal device 11 to the wireless access device 10. The downlink transmission is defined as data communications from the wireless access device 10 to the wireless terminal device 11. For example, the wireless access device 10 can restrict the uplink transmission data of the wireless terminal device 11 to be transmitted on the third link L3 according to a TID-to-Link Mapping mechanism. Therefore, as shown in FIG. 2, after data D1 is transmitted from the wireless access device 10 to the wireless terminal device 11, the wireless terminal device 11 can generate a block acknowledgment message BA1 to the wireless access device 10 for reporting the data reception status. After data D2 is transmitted from the wireless access device 10 to the wireless terminal device 11, the wireless terminal device 11 can generate a block acknowledgment message BA2 to the wireless access device 10 for reporting the data reception status. After data D3 is transmitted from the wireless access device 10 to the wireless terminal device 11, the wireless terminal device 11 can generate a block acknowledgment message BA3 to the wireless access device 10 for reporting the data reception status. After data D4 is transmitted from the wireless access device 10 to the wireless terminal device 11, the wireless terminal device 11 can generate a block acknowledgment message BA4 to the wireless access device 10 for reporting the data reception status. For the uplink transmission, after data D5 is transmitted from the wireless terminal device 11 to the wireless access device 10, the wireless access device 10 can generate a block acknowledgment message BA5 to the wireless terminal device 11 to report the data reception status.

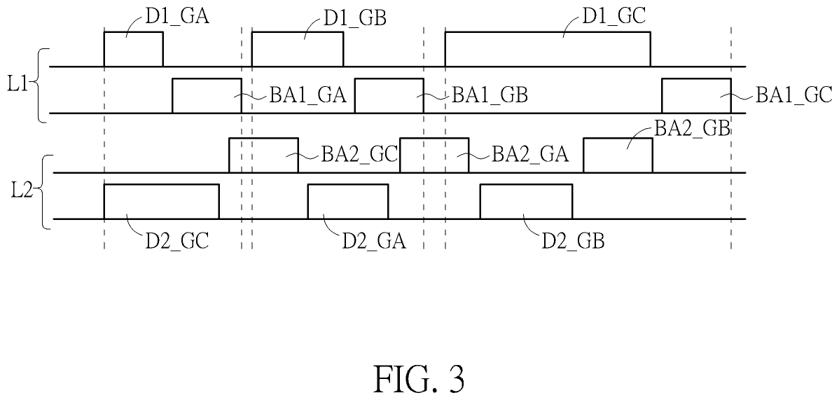

FIG. 3 is an illustration of partitioning a plurality of wireless terminals and then transmitting downlink transmission data to different wireless terminal device groups at different time intervals of the wireless communication system 100. When the wireless communication system 100 includes a plurality of wireless terminal devices, the group scheduling device 10e can partition the wireless terminal devices into at least two groups, such as a wireless terminal device group A, a wireless terminal device group B, and a wireless terminal device group C. As mentioned previously, the uplink transmission data and the downlink transmission data are allocated to different links. In FIG. 3, when group data D1_GA is transmitted from the wireless access device 10 to the wireless terminal device group A through the first link L1, the second link L2 can be used to transmit group data D2_GC from the wireless terminal device group C to the wireless access device 10. After the group data D1_GA is transmitted, the wireless terminal device group A can generate a block acknowledgment message group BA1 GA to the wireless access device 10 for reporting data reception status information. After the group data D2_GC is transmitted, the wireless access device 10 can generate a block acknowledgment message group BA2_GC to the wireless terminal device group C. Here, the second link L2 can also be used for transmitting the group data D2_GB from the wireless terminal device group B to the wireless access device 10. Specifically, the group data D2_GA cannot be transmitted from the wireless terminal device group A to the wireless access device 10 through the second link L2 at this time since the uplink transmission and downlink transmission cannot be simultaneously performed by the wireless terminal device group A. Then, when group data D1_GB is transmitted from the wireless access device 10 to the wireless terminal device group B through the first link L1, the second link L2 can be used for transmitting group data D2_GA from the wireless terminal device group A to the wireless access device 10. After the group data D1_GB is transmitted, the wireless terminal device group B can generate a block acknowledgment message group BA1 GB to the wireless access device 10 for reporting data reception status information. After the group data D2_GA is transmitted, the wireless access device 10 can generate a block acknowledgment message group BA2_GA to the wireless terminal device group A. Here, the second link L2 can also be used for transmitting the group data D2_GC from the wireless terminal device group C to the wireless access device 10. Specifically, the group data D2_GB cannot be transmitted from the wireless terminal device group B to the wireless access device 10 through the second link L2 at this time since the uplink transmission and downlink transmission cannot be simultaneously performed by the wireless terminal device group B. Then, when group data D1_GC is transmitted from the wireless access device 10 to the wireless terminal device group C through the first link L1, the second link L2 can be used for transmitting group data D2_GB from the wireless terminal device group B to the wireless access device 10. After the group data D1_GC is transmitted, the wireless terminal device group C can generate a block acknowledgment message group BA1 GC to the wireless access device 10 for reporting data reception status information. After the group data D2_GB is transmitted, the wireless access device 10 can generate a block acknowledgment message group BA2_GB to the wireless terminal device group B. Here, the second link L2 can also be used for transmitting the group data D2_GA from the wireless terminal device group A to the wireless access device 10. Specifically, the group data D2_GC cannot be transmitted from the wireless terminal device group C to the wireless access device 10 through the second link L2 at this time since the uplink transmission and downlink transmission cannot be simultaneously performed by the wireless terminal device group C.

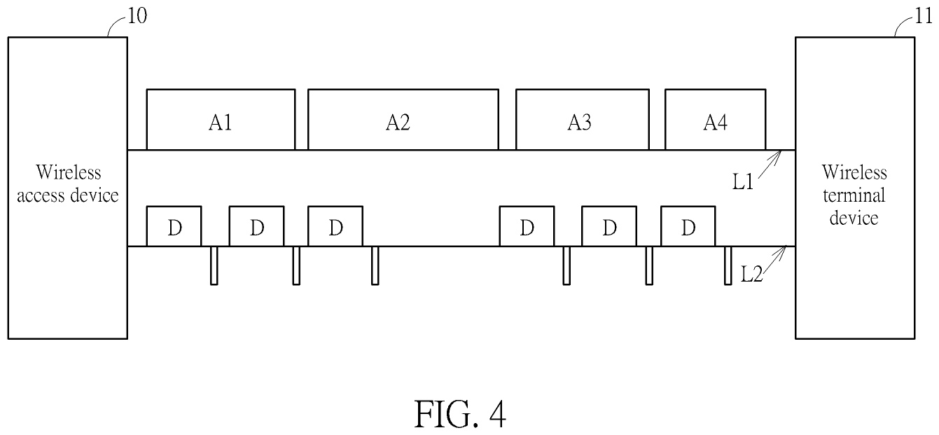

FIG. 4 is an illustration of allocating a data link layer management flow and control frame data to a specific link of the wireless communication system 100. In FIG. 4, the transmission allocation device 10d allocates the data link layer management flow and the control frame data to the first link L1. For example, a data link layer management flow A1 can be an authentication flow. A data link layer management flow A2 can be an association flow. A link layer management flow data A3 can be an operation mode change flow. A link layer management flow A4 can be a TID-to-Link mapping data flow. However, the present invention is not limited thereto. For example, the transmission allocation device 10d can allocate a block acknowledgment request, the block acknowledgment message, or the control frame data to the first link L1. The first link L1 corresponds to an uplink transmission link. In FIG. 4, the data link layer management flows A1 to A4 are allocated to the first link L1. A plurality of downlink transmission data blocks D are allocated to the second link L2. By doing so, the channel occupancy rate of the multi-link operation can be increased.

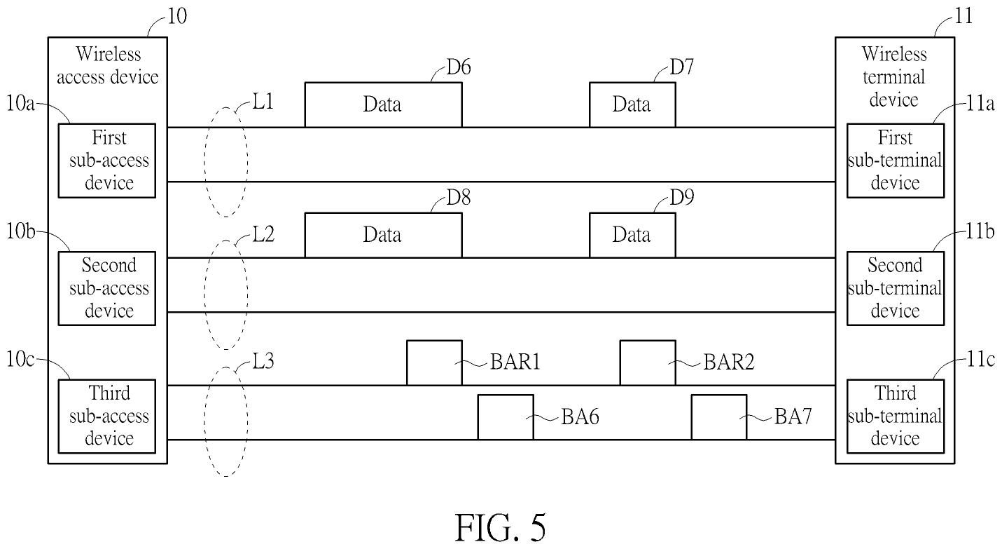

FIG. 5 is an illustration of allocating the block acknowledgment request and the block acknowledgment message to a specific link of the wireless communication system 100. The wireless access device 10 can generate a block acknowledgment request to the wireless terminal device 11 for requesting the wireless terminal device 11 to report the data reception status information. Further, after the wireless terminal device 11 receives the block acknowledgment request, the wireless terminal device 11 can generate the block acknowledgment message to the wireless access device 10. In FIG. 5, when data D6 and data D8 are transmitted from the wireless access device 10 to the wireless terminal device 11 through the first link L1 and the second link L2 respectively, a block acknowledgment request BAR1 can be generated. The block acknowledgment request BAR1 can be transmitted from the wireless access device 10 to the wireless terminal device 11 through the third link L3. Then, after the block acknowledgment request BAR1 is received by the wireless terminal device 11, the wireless terminal device 11 can generate a block acknowledgment message BA6 to the wireless access device 10 through the third link L3. Similarly, when the data D7 and data D9 are transmitted from the wireless access device 10 to the wireless terminal device 11 through the first link L1 and the second link L2 respectively, a block acknowledgment request BAR2 can be generated. The block acknowledgment request BAR2 can be transmitted from the wireless access device 10 to the wireless terminal device 11 through the third link L3. Then, after the block acknowledgment request BAR2 is received by the wireless terminal device 11, the wireless terminal device 11 can generate a block acknowledgment message BA7 to the wireless access device 10 through the third link L3. In other words, the downlink transmission data of the wireless access device 10 can be allocated to the first link L1 and the second link L2. The block acknowledgment requests and the block acknowledgment messages can be allocated to the third link L3. The third link L3 corresponds to the uplink transmission link.

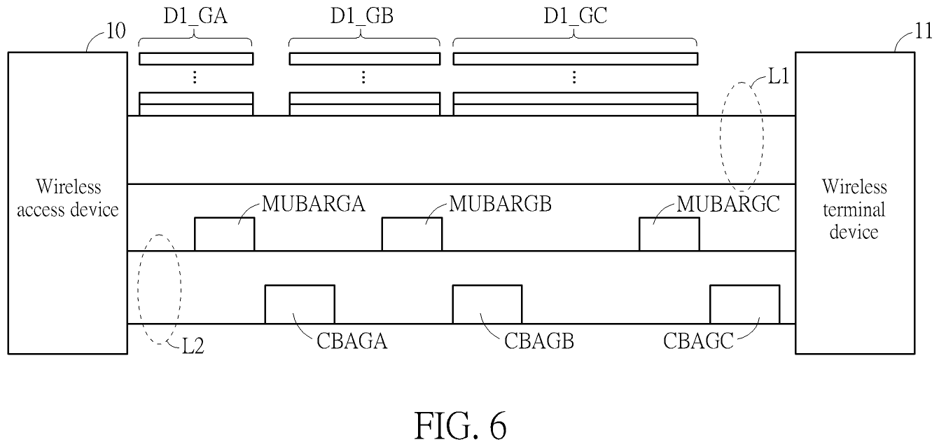

FIG. 6 is an illustration of allocating the block acknowledgment request and the block acknowledgment message to a specific link for multi-users of the wireless communication system 100. For multi-users, as mentioned previously, the plurality of wireless terminal devices can be portioned into several groups, such as the wireless terminal device group A, the wireless terminal device group B, and the wireless terminal device group C. In FIG. 6, when group data D1_GA is transmitted from the wireless access device 10 to the wireless terminal device group A through the first link L1, a block acknowledgment request group MUBARGA can be generated. The block acknowledgment request group MUBARGA can be transmitted from the wireless access device 10 to the wireless terminal device group A through the second link L2. Then, after the wireless terminal device group A receives the block acknowledgment request group MUBARGA, a block acknowledgment message group CBAGA can be generated to the wireless access device 10 through the second link L2. Similarly, when group data D1_GB is transmitted from the wireless access device 10 to the wireless terminal device group B through the first link L1, a block acknowledgment request group MUBARGB can be generated. The block acknowledgment request group MUBARGB can be transmitted from the wireless access device 10 to the wireless terminal device group B through the second link L2. Then, after the wireless terminal device group B receives the block acknowledgment request group MUBARGB, a block acknowledgment message group CBAGB can be generated to the wireless access device 10 through the second link L2. Similarly, when group data D1_GC is transmitted from the wireless access device 10 to the wireless terminal device group C through the first link L1, a block acknowledgment request group MUBARGC can be generated. The block acknowledgment request group MUBARGC can be transmitted from the wireless access device 10 to the wireless terminal device group C through the second link L2. Then, after the wireless terminal device group C receives the block acknowledgment request group MUBARGC, a block acknowledgment message group CBAGC can be generated to the wireless access device 10 through the second link L2. Here, the second link corresponds to the uplink transmission link.

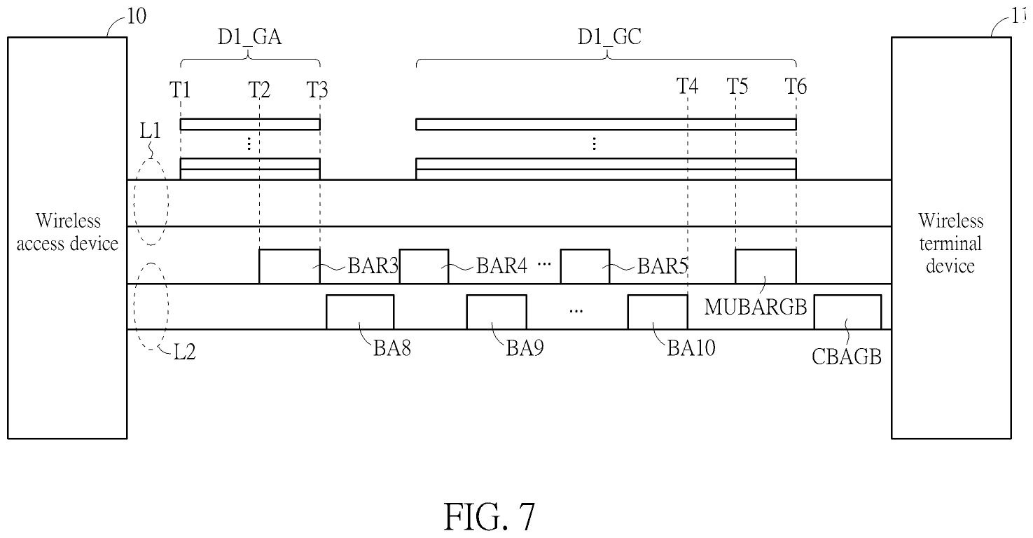

FIG. 7 is an illustration of time points for multi-users of the wireless communication system 100. In FIG. 7, a time point T1 can be defined as a start time point of transmitting the group data D1_GA from the wireless access device 10 to the wireless terminal device group A through the first link L1. A time point T2 is defined by forwardly shifting a time length of a block acknowledgment request BAR3 from a time point T3. The time point T2 is also defined as a start time point of transmitting the block acknowledgment request BAR3 from the wireless access device 10 to a certain wireless terminal device of the wireless terminal device group A through the second link L2. The time point T3 can be defined as a common transmission ending time point of the group data D1_GA and the block acknowledgment request BAR3. Further, at the time point T3, the common transmission ending time can be extended. Therefore, the wireless terminal device group A has enough time to generate and transmit at least one block acknowledgment message to the wireless access device 10. Here, after a wireless terminal device receives the block acknowledgment request BAR3, the wireless terminal device can generate the block acknowledgment message BA8 to the wireless access device 10. Similarly, after a wireless terminal device receives a block acknowledgment request BAR4, the wireless terminal device can generate a block acknowledgment message BA9 to the wireless access device 10, and so on. After a wireless terminal device receives a block acknowledgment request BAR5, the wireless terminal device can generate a block acknowledgment message BA9 to the wireless access device 10. A time point T4 is defined as an ending time point of completely transmitting a series of block acknowledgment messages. Further, group data D1_GB can also be transmitted by the wireless access device 10 to the wireless terminal device group B through the first link L1. A time point T5 is defined by forwardly shifting a time length of a block acknowledgment request group MUBARGB from a time point T6. The time point T5 is also defined as a start time point of transmitting the block acknowledgment request group MUBARGB from the wireless access device 10 to the wireless terminal device group A through the second link L2. A time point T6 can be defined as a common transmission ending time point of the group data D1_GB and the block acknowledgment request group MUBARGB. Similarly, at the time point T6, the common transmission ending time can be extended. Therefore, the wireless terminal device group B has enough time to generate and transmit a block acknowledgment message group CBAGB to the wireless access device 10.

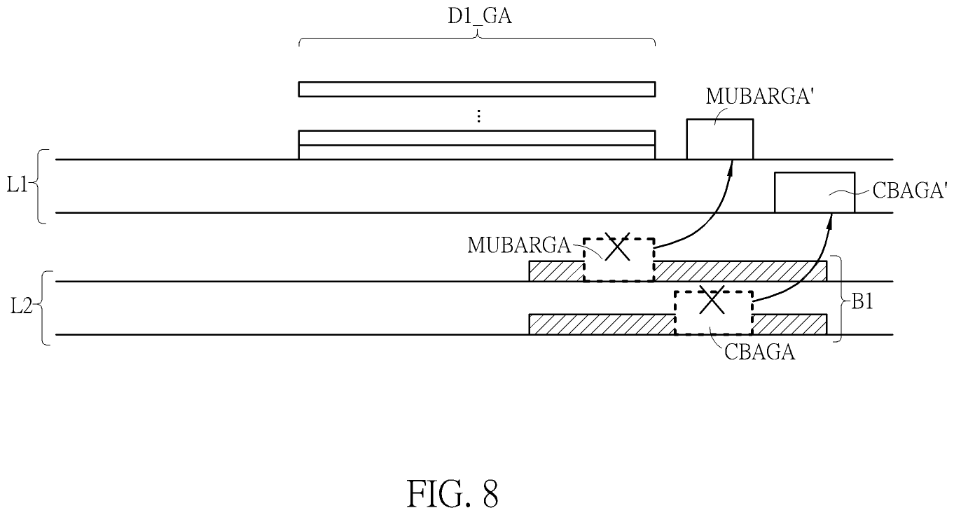

FIG. 8 is an illustration of introducing an unexpected link busy state for multi-users to the wireless communication system 100. In FIG. 8, the wireless access device 10 and the wireless terminal device 11 are connected through the first link L1 and the second link L2. The group data D1_GA is transmitted from the wireless access device 10 to the wireless terminal device group A through the first link L1. However, the second link L2 is detected as an occupied status after transmission of the group data D1_GA is enabled. Here, time duration of the occupied status is denoted as B1. Specifically, the occupied status of the second link L2 is unexpected. Since a bandwidth of the second link L2 is occupied during the time duration B1, the second link L2 is unavailable. Therefore, the second link L2 cannot be used for carrying a block acknowledgment request group MUBARGA. Thus, the wireless access device 10 can allocate the block acknowledgment request group MUBARGA to the first link L1, denoted as an adjusted block acknowledgment request group MUBARGA′ hereafter. In other words, after the group data D1_GA is transmitted from the wireless access device 10 to the wireless terminal device group A through the first link L1, the wireless access device 10 can transmit the adjusted block acknowledgment request group MUBARGA′ to the wireless terminal device group A. Similarly, since a bandwidth of the second link L2 is occupied during the time duration B1, the second link L2 is unavailable. Therefore, the second link L2 cannot be used for carrying a block acknowledgment message group CBAGA. Thus, the wireless terminal device group A can allocate the block acknowledgment message group CBAGA to the first link L1, denoted as an adjusted block acknowledgment message group CBAGA′ hereafter. After the adjusted block acknowledgment request group MUBARGA′ is received by the wireless terminal device group A through the first link L1, the wireless terminal device group A can transmit the adjusted block acknowledgment message group CBAGA′ through the first link L1 to the wireless access device 10. In other words, the downlink transmission data of the wireless access device 10 can be allocated to the first link L1. The wireless access device 10 can detect the status of the second link L2. When the second link L2 is detected as the occupied status after the downlink transmission is enabled by the wireless access device 10, the block acknowledgment request (or the block acknowledgment request group) can be allocated to the first link.

In another embodiment, the second link L2 is detected as the occupied status before the downlink transmission is enabled by the wireless access device 10. It implies that the occupied status of the second link L2 is expected. Therefore, an implicit block acknowledgment request can be introduced to downlink transmission data by the wireless access device 10 for reducing a block acknowledgment request frame overhead.

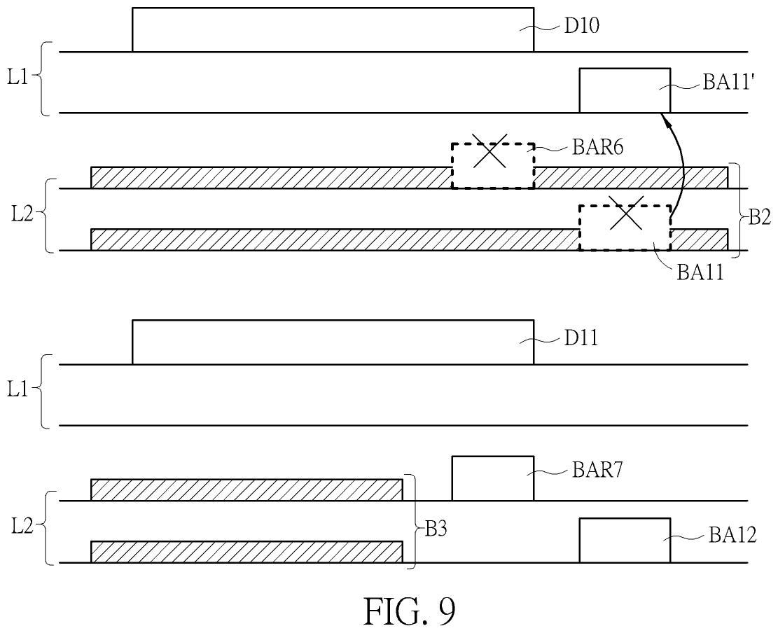

FIG. 9 is an illustration of introducing an expected link busy state of the wireless communication system 100. The expected busy state of the link can be categorized as two types. In a first type, a busy time duration B2 of the second link L2 will occupy a block acknowledgment request BAR6 and a block acknowledgment message BA11. In a second type, a busy time duration B3 of the second link L2 will not occupy a block acknowledgment request BAR7 and a block acknowledgment message BA12. In the first type, as mentioned previously, the wireless access device 10 can add an implicit block acknowledgment request to the downlink transmission data. Thus, the block acknowledgment request BAR6 transmitted on the second link L2 during the busy time duration B2 can be avoided. Further, the wireless terminal device 11 can allocate the block acknowledgment message BA11 to the first link L1 as an adjusted block acknowledgment message BA11′ In the second type, although the second link L2 is expected to be busy during the busy time duration B3, the busy time duration B3 of the second link L2, the block acknowledgment request BAR7, and the block acknowledgment message BA12 are non-overlapped. Thus, transmission formats of the block acknowledgment request BAR7 and the block acknowledgment message BA12 are maintained. Configurations of the second link L2 can also be maintained.

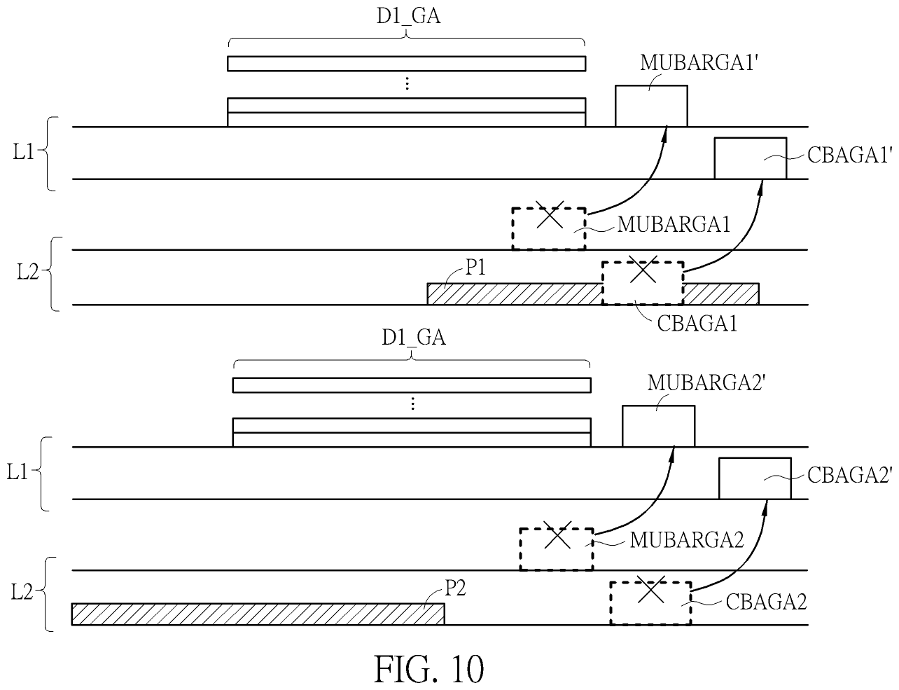

FIG. 10 is an illustration of introducing an expected link power saving state for multi-users to the wireless communication system 100. The expected link power saving state of the second link L2 can be categorized as two types. In a first type, a power saving time duration P1 of the second link L2 will occupy a block acknowledgment request group MUBARGA1 and a block acknowledgment message group CBAGA1. In a second type, a power saving time duration P2 of the second link L2 will not occupy a block acknowledgment request group MUBARGA2 and a block acknowledgment message group CBAGA2. However, although a start time point of enabling the power saving state of the second link L2 is expected, the wireless access device 10 cannot predict an ending time point of disabling the power saving of the second link L2. Therefore, regardless of the first type or the second type, the block acknowledgment request group and the block acknowledgment message group are allocated to the first link L1. For example, in FIG. 10, a block acknowledgment request group MUBARGA1 transmitted on the second link L2 is adjusted as a block acknowledgment request group MUBARGA1′ transmitted on the first link L1. A block acknowledgment message group CBAGA1 transmitted on the second link L2 is adjusted as a block acknowledgment message group CBAGA1′ transmitted on the first link L1. Similarly, a block acknowledgment request group MUBARGA2 transmitted on the second link L2 is adjusted as a block acknowledgment request group MUBARGA2′ transmitted on the first link L1. A block acknowledgment message group CBAGA2 transmitted on the second link L2 is adjusted as a block acknowledgment message group CBAGA2′ transmitted on the first link L1.

To sum up, the present invention discloses a wireless communication method, a wireless access device, and a wireless terminal device capable of supporting a multi-link operation mode. First, the wireless access device and the wireless terminal device are connected through at least two links (i.e., the first link and the second link). Then, link analysis units can identify the first link and the second link, and then acquire status information of the first link and the second link. Then, the wireless access device can allocate uplink transmission data and downlink transmission data to the first link and the second link according to the status information of the first link and the second link. A purpose of the wireless communication method of the present invention is to reduce the collision probability between uplink transmission data and downlink transmission data. In other words, since the uplink transmission data and the downlink transmission data are appropriately allocated to the first link and the second link, the transmission latency can be reduced. For example, when the wireless communication method is applied to media streaming applications and video games, it can provide high communication stability, high quality of service (QoS), and high real-time communication quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless access device capable of supporting a multi-link operation mode comprising:
a first sub-access device configured to establish a first link to a wireless terminal device, the first sub-access device comprising:
a first link access analysis unit configured to identify and analyze the first link; and
a first access transceiver unit configured to transmit data;
a second sub-access device configured to establish a second link to the wireless terminal device, the second sub-access device comprising:
a second link access analysis unit configured to identify and analyze the second link; and
a second access transceiver unit configured to transmit data;
a transmission allocation device coupled to the first sub-access device and the second sub-access device and configured to determine communication modes of an uplink transmission and a downlink transmission, or determine allocation modes of a data link layer management flow, the first link, and the second link; and
a group scheduling device coupled to the first sub-access device, the second sub-access device, and the transmission allocation device and configured to partition a plurality of wireless terminal devices into at least two groups, and configured to control the transmission allocation device to transmit downlink transmission data to different wireless terminal device groups at different time intervals.

2. The wireless access device of claim 1, wherein the transmission allocation device allocates uplink transmission data of the wireless access device to the first link, and allocates downlink transmission data of the wireless access device to the second link.

3. The wireless access device of claim 1, wherein the transmission allocation device allocates uplink transmission data of a wireless terminal device group to the first link, and allocates downlink transmission data of the wireless terminal device group to the second link.

4. The wireless access device of claim 1, wherein the transmission allocation device allocates the data link layer management flow and control frame data to the first link, and allocates downlink transmission data of the wireless access device to the second link.

5. The wireless access device of claim 1, wherein transmission allocation device generates a block acknowledgment request to the wireless terminal device, the wireless terminal device reports data reception status information according to the block acknowledgment request, and after the wireless terminal device receives the block acknowledgment request, the wireless terminal device generates a block acknowledgment message to the wireless access device.

6. The wireless access device of claim 5, wherein downlink transmission data of the wireless access device is allocated to the first link, the block acknowledgment request and the block acknowledgment message are allocated to the second link, and the second link corresponds to an uplink transmission link.

7. The wireless access device of claim 5, wherein downlink transmission data of the wireless access device is allocated to the first link, the wireless access device detects a status of the second link, and when the second link is detected as an occupied status after downlink transmission is enabled by the wireless access device, the block acknowledgment request is allocated to the first link.

8. The wireless access device of claim 7, wherein when the second link is detected as the occupied status before the downlink transmission is enabled by the wireless access device, an implicit block acknowledgment request is added to downlink transmission data by the wireless access device.

9. A wireless terminal device capable of supporting a multi-link operation mode comprising:
a first sub-terminal device configured to establish a first link to a wireless access device, the first sub-terminal device comprising:
a first link terminal analysis unit configured to identify and analyze the first link; and
a first terminal transceiver unit configured to receive data;
a second sub-terminal device configured to establish a second link to the wireless access device, the second sub-terminal device comprising:
a second link terminal analysis unit configured to identify and analyze the second link; and
a second terminal transceiver unit configured to receive data;
a receiving state detection device coupled to the first sub-terminal device and the second sub-terminal device and configured to detect receiving states of the first link and the second link, and configured to generate a block acknowledgment message according to the receiving states; and
a terminal transmission allocation device coupled to the first sub-terminal device and the second sub-terminal device and configured to determine allocation modes of a data link layer management flow, the first link, and the second link.

10. The wireless terminal device of claim 9, wherein the wireless terminal device receives a block acknowledgment request transmitted from the wireless access device, the wireless terminal device reports data reception status information according to the block acknowledgment request, and after the wireless terminal device receives the block acknowledgment request, the wireless terminal device generates the block acknowledgment message to the wireless access device.

11. The wireless terminal device of claim 10, wherein downlink transmission data of the wireless access device is allocated to the first link, the block acknowledgment request and the block acknowledgment message are allocated to the second link, and the second link corresponds to an uplink transmission link.

12. The wireless terminal device of claim 10, wherein downlink transmission data of the wireless access device is allocated to the first link, the wireless access device detects a status of the second link, and when the second link is detected as an occupied status after downlink transmission is enabled by the wireless access device, the block acknowledgment request is allocated to the first link.

13. The wireless terminal device of claim 12, wherein when the second link is detected as the occupied status before the downlink transmission is enabled by the wireless access device, an implicit block acknowledgment request is added to the downlink transmission data.

14. A wireless communication method capable of supporting a multi-link operation mode comprising:
establishing a data connection between a wireless access device and a wireless terminal device through a first link and a second link;
identifying the first link and the second link;
acquiring link status information of the first link and the second link; and
allocating uplink transmission data, downlink transmission data, or a data link layer management flow to the first link and the second link by the wireless access device according to the link status information of the first link and the second link;
wherein the first link and the second link have different frequencies.

15. The wireless communication method of claim 14, further comprising:
acquiring a plurality of wireless terminal devices;
partitioning the plurality of wireless terminal devices into at least two groups; and
transmitting the downlink transmission data to different wireless terminal device groups at different time intervals;
wherein during a first time interval, a first wireless terminal device group receives first downlink transmission data from the first link, a second wireless terminal device group transmits second downlink transmission data to the second link, and during a second time interval, the second wireless terminal device group receives third downlink transmission data from the first link, the first wireless terminal device group transmits fourth downlink transmission data to the second link.

16. The wireless communication method of claim 14, wherein the data link layer management flow and control frame data of the wireless access device are allocated to the first link, and the downlink transmission data of the wireless access device is allocated to the second link.

17. The wireless communication method of claim 14, further comprising:
transmitting a block acknowledgment request from the wireless access device to the wireless terminal device;
reporting data reception status information by the wireless terminal device according to the block acknowledgment request;
generating a block acknowledgment message by the wireless terminal device after the wireless terminal device receives the block acknowledgment request; and
transmitting the block acknowledgment message from the wireless terminal device to the wireless access device.

18. The wireless communication method of claim 17, wherein the downlink transmission data of the wireless access device is allocated to the first link, the block acknowledgment request and the block acknowledgment message are allocated to the second link, and the second link corresponds to an uplink transmission link.

19. The wireless communication method of claim 17, wherein the downlink transmission data of the wireless access device is allocated to the first link, the wireless access device detects a status of the second link, and when the second link is detected as an occupied status after downlink transmission is enabled by the wireless access device, the block acknowledgment request is allocated to the first link.

20. The wireless communication method of claim 19, wherein when the second link is detected as the occupied status before the downlink transmission is enabled by the wireless access device, an implicit block acknowledgment request is added to the downlink transmission data.
